(19) United States
(12) Patent Application Publication
(10) Pub. No.: US 2023/0160533 A1
(43) Pub. Date: May 25, 2023

(54) LIQUID HYDROGEN TRAILER LOADING PROCEDURE FOR HYDROGEN AND REFRIGERATION RECOVERY

(71) Applicant: L'Air Liquide, Societe Anonyme pour l'Etude et l?Exploitation des Procedes Georges Claude, Paris (FR)

(72) Inventors: Bertrand DEMOLLIENS, Paris (FR); Richard DUBETTIER, La Varenne Saint Hilaire (FR); Teixeira GUILLAUME, Paris (FR); Michael A. TURNEY, Houston, TX (US)

(73) Assignee: L'Air Liquide, Societe Anonyme pour l'Etude et l?Exploitation des Procedes Georges Claude, Paris (FR)

(21) Appl. No.: 17/533,623

(22) Filed: Nov. 23, 2021

(51) Int. Cl. F17C 7/02

(52) U.S. Cl. CPC F17C 7/02; F17C 2221/012; F17C 2223/0161; F17C 2265/065; F17C 2225/033; F17C 2270/0171; F17C 2225/0153; F17C 2227/0157; F17C 2227/0135; F17C 2265/03

(57) ABSTRACT

The present invention is at least industrially applicable to recovery of Hydrogen boil off gas during tube trailer refilling with liquid Hydrogen by a sequences of steps that redirects gaseous Hydrogen from the tube trailer to a Hydrogen liquefaction plant.

### BACKGROUND

### Technical Field

The disclosure relates to management of Hydrogen boil off gas during refilling of liquid Hydrogen into a Hydrogen tube trailer.

### Background Art

Liquid Hydrogen is produced and stored by a number of means, but generally the liquid Hydrogen is stored in a cryogenic storage tank on or near the source of Hydrogen liquefaction and often also the original Hydrogen source, such as an electrolyzer. Liquid Hydrogen is transferred from this cryogenic storage container to cryogenic tube trailers for transport to remote sites, e.g., a Hydrogen filling station for H2 FCEVs.

Hydrogen boil off gas can result in significant losses of Hydrogen and, indirectly, energy used to refrigerate the Hydrogen. One particular point of boil off gas loss can be refilling a previously used Hydrogen tube trailer with a new load of liquid Hydrogen. When the tube trailers are returned to the cryogenic storage tank for refilling, the tube trailers will normally contain some residual liquid Hydrogen and a volume of cold, but gaseous Hydrogen. Furthermore, additional gaseous Hydrogen forms when refilling the tube trailer as the liquid Hydrogen cools the tube trailer walls. One option for handling this gaseous Hydrogen during the refilling process include simply venting the Hydrogen, possibly with flaring. Obviously this results in loss of both the Hydrogen and the energy used in its creation and liquefaction. An alternative to venting is to collect the Hydrogen boil off gas during the refilling process and store the gaseous Hydrogen in a gashouse (pressurized slightly above atmospheric pressure), and then recompress and feed this boil off gas Hydrogen into the Hydrogen feed stream entering the liquefaction plant. This preserves the Hydrogen, but most of the refrigeration retained by the cold Hydrogen boil off gas is lost.

### SUMMARY

There is disclosed a method for refilling a liquid Hydrogen tube trailer with liquid Hydrogen. The method includes the steps of: a) Creating a fluidic communication between a volume of gaseous Hydrogen within the liquid Hydrogen tube trailer a gaseous Hydrogen headspace of a cryogenic storage container having a volume of liquid Hydrogen therein and a volume of gaseous Hydrogen forming a headspace therein; b) allowing a pressure of the gaseous Hydrogen volumes to equalize, whereby a majority of the gaseous Hydrogen within the liquid Hydrogen tube trailer is moved by a first pressure difference into the headspace of the cryogenic storage container; c) opening a fluidic communication between a liquid Hydrogen output stream from a Hydrogen liquefaction plant and the tube trailer, thereby moving liquid Hydrogen into the liquid Hydrogen tube trailer due to a second pressure difference, to form a volume of liquid Hydrogen within the liquid Hydrogen tube trailer; d) opening a further fluidic communication between a remaining gaseous Hydrogen volume within the liquid Hydrogen tube trailer, the headspace of the cryogenic storage container and the Hydrogen liquefaction plant, which is capable of recondensing the gaseous Hydrogen, from the liquid Hydrogen tube trailer and the headspace of the cryogenic storage container, whereby a portion of the gaseous Hydrogen is moved by a third pressure difference from the liquid Hydrogen tube trailer and the headspace of the cryogenic storage container to the Hydrogen liquefaction plant; e) once the liquid Hydrogen tube trailer is partially refilled with liquid Hydrogen, closing the fluidic communication with the headspace of the cryogenic storage container from step b) and the fluidic connection between the liquid Hydrogen output stream from a Hydrogen liquefaction plant and the tube trailer from step c), wherein the fluidic communication between the liquid Hydrogen tube trailer and the Hydrogen liquefaction plant from step d) remains open; f) opening a fluidic communication between the liquid Hydrogen output stream from a Hydrogen liquefaction plant and the volume of liquid Hydrogen in the cryogenic storage container; g) opening a fluidic communication between the volume of liquid Hydrogen in the cryogenic storage container and the volume of liquid Hydrogen within the liquid Hydrogen tube trailer, whereby an additional an additional volume of liquid Hydrogen is added to the liquid Hydrogen tube trailer due to a fourth pressure differential; and h) closing the fluidic communications of step g) when a pre-defined set of condition(s) indicates that refilling is complete.

The above-described method may include one or more of the following aspects:
any one of the first to the fourth pressure differences are created, at least in part, by gas compression or liquid pumping.
the first pressure difference is due to the liquid Hydrogen tube trailer having a gaseous Hydrogen pressure of 7-10 bar and the cryogenic storage tank having a headspace pressure of 1-2 bar.
the headspace pressure in the cryogenic storage tank after step b), and before step c), is 0.1 to 1.0 bar higher than prior to step b).
step e) begins when the liquid Hydrogen tube trailer is determined to be partially refilled based on a temperature of the tube trailer wall still in contact with gaseous Hydrogen being less than 200 K, preferably less than 150 K, such as 100-120 K.
step e) begins when the liquid Hydrogen tube trailer is determined to be partially refilled based on a liquid Hydrogen volume occupying at least 30% of an interior total volume of the liquid Hydrogen tube trailer, more preferably at least 40%, and most preferably 45-55%.
the pre-defined set of condition(s) indicates that refilling is complete in step h) comprises a liquid Hydrogen volume occupying at least 90% of an interior total volume of the liquid Hydrogen tube trailer, more preferably at least 93%, and most preferably 93-95%.

### BRIEF DESCRIPTION OF DRAWINGS

FIG. 1 shows step 1, depressurization of the tube trailer.

FIG. 2 shows step 2, Refill Stage One.

FIG. 3 shows step 3, Refill Stage Two.

FIG. 4 show a system for carrying out the method.

### DETAILED DESCRIPTION

The method is carried out at a location having at least a) a Hydrogen liquefaction system (1) capable of producing a pressurized feed stream of liquid Hydrogen (2) and b) a cryogenic storage tank (3) fluidically connected to the Hydrogen liquefaction system (1) and capable of receiving and holding a volume of the liquid Hydrogen (10). Hydrogen liquefaction systems and cryogenic Hydrogen storage tanks are well known in the art.

Liquid Hydrogen tube trailers (6) are also well known in the art and are commonly used to transport liquid Hydrogen to locations using Hydrogen such as Hydrogen fuel cell electric vehicle (FCEV) refilling stations.

The method disclosed herein begins with a returning Hydrogen delivery vehicle (7) transporting a used Hydrogen tube trailer (6) to the Hydrogen liquefaction plant (1). Generally the Hydrogen tube trailer (6) will contain a residual, pressurized, sub-ambient temperature Hydrogen gas (8) and a small amount of liquid Hydrogen (9). A representative case is 7-10 bar pressure Hydrogen gas at 100 K with liquid Hydrogen at 31.2 K occupying 10-15% of the tube trailer volume. The onsite cryogenic storage tank (3) will generally have a volume of liquid Hydrogen (10) and a headspace (11) of cold, gaseous Hydrogen. The cryogenic storage tank headspace (11) will generally be at a lower pressure than the tube trailer gas, a pressure of around 1-2 bar in some cases.

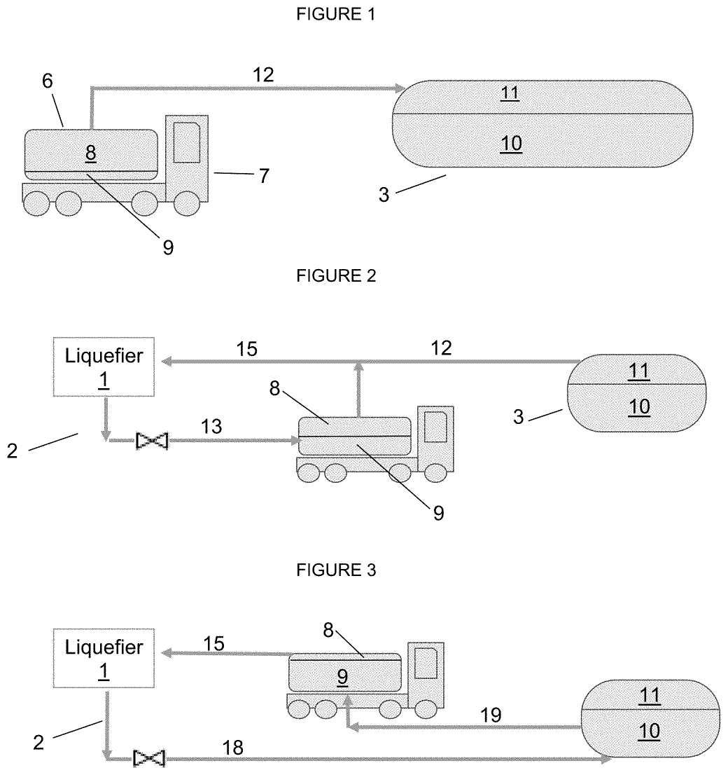

The first step of the method (FIG. 1) is to fluidically connect (12) the tube trailer (6) to the onsite cryogenic storage tank (3) of the liquefaction plant. Both the tube trailer and the cryogenic storage tank are fluidically connected at a point in communication with the gaseous Hydrogen therein (the headspaces 8, 11). This is a depressurization step due to the pressure differential between the tube trailer and the cryogenic storage tank. The two headspaces (8, 11) are allowed to reach pressure equilibrium. As a result, a majority of the Hydrogen in the tube trailer (6) is transferred to the cryogenic storage tank (3). At the end, the equalized pressures may for example be 0.1 to 1.0 bar higher than the starting headspace pressure of the cryogenic storage tank. The pressure in the cryogenic storage tank will eventually be reduced due to condensation of Hydrogen gas.

In the second step of the method (FIG. 2; Refill Stage One), a fluidic connection (13) is opened between the liquefier's liquid Hydrogen stream and the tube trailer. The liquid Hydrogen is at sufficient pressure to enable filling of the tube trailer. The fluidic connection between the headspaces (12) from the first step remains open. The two headspaces (8, 11) are then further fluidically connected to the liquefaction plant (15). As liquid Hydrogen fills the tube trailer, the remaining gaseous Hydrogen, and any generated during the filling, are pushed out of the tube trailer (15) and into the fluidically connected cryogenic storage tank headspace and the liquefaction plant. The gaseous Hydrogen may feed into the incoming gaseous Hydrogen stream going into the liquefaction plant, and/or be introduced at various points within the liquefaction system, for recondensation to liquid Hydrogen. Refill Stage One proceeds until the tube trailer is partially filled with liquid Hydrogen, preferably at least until the temperature of the tube trailer wall still in contact with gaseous Hydrogen is less than 200 K, preferably less than 150 K, such as 100-120 K. In some preferred embodiments, Refill Stage One proceeds until the tube trailer volume is at least 30% filled with liquid Hydrogen, more preferably at least 40%, and most preferably 45-55%.

In the third stage of the method (FIG. 3; Refill Stage Two), the fluidic communication with the cryogenic storage tank headspace is closed (12); and the fluidic communication between the liquid Hydrogen outlet stream (13) and the tube trailer is also closed. A fluidic communication is opened between the liquid Hydrogen outlet stream from the liquefaction plant and the liquid Hydrogen containing portion of the cryogenic storage tank (18). Additionally, a fluidic connection is opened between the same liquid Hydrogen containing portion of the cryogenic storage tank and the liquid Hydrogen containing portion of the Hydrogen tube trailer (19). Liquid Hydrogen is then pushed by pressure differential into the tube trailer to continue the refilling process, while very cold Hydrogen gas exits the tube trailer and goes back to the liquefaction plant (15). Refill Stage Two proceeds until the tube trailer is filled, generally with 90-95% liquid Hydrogen, at which point the refilling operation is stopped.

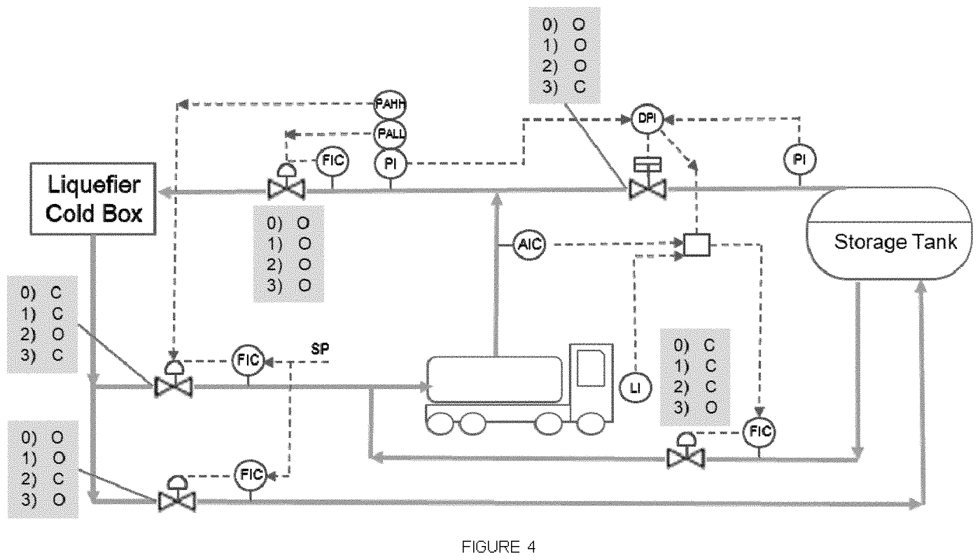

FIG. 4 illustrates a system configured and adapted to execute the above method. Generally the system is operated by a computer that actuates valves to control the fluidic communications of the above method in the proper sequence. In FIG. 4, for each valve, the open/closed position of the valve (0/C) is indicated for the start 0 prior to execution of the method and then each of steps 1)-3) of the method: 1) Depressurization; 2) Refill Stage One; 3) Refill Stage Two.

### INDUSTRIAL APPLICABILITY

The present invention is at least industrially applicable to recovery of Hydrogen boil off gas during tube trailer refilling with liquid Hydrogen.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1. A method for refilling a liquid Hydrogen tube trailer with liquid Hydrogen, the method comprising the steps of:
a) creating a fluidic communication between a volume of gaseous Hydrogen within the liquid Hydrogen tube trailer a gaseous Hydrogen headspace of a cryogenic storage container having a volume of liquid Hydrogen therein and a volume of gaseous Hydrogen forming a headspace therein,
b) allowing a pressure of the gaseous Hydrogen volumes to equalize,
whereby a majority of the gaseous Hydrogen within the liquid Hydrogen tube trailer is moved by a first pressure difference into the headspace of the cryogenic storage container,
c) opening a fluidic communication between a liquid Hydrogen output stream from a Hydrogen liquefaction plant and the tube trailer, thereby moving liquid Hydrogen into the liquid Hydrogen tube trailer due to a second pressure difference, to form a volume of liquid Hydrogen within the liquid Hydrogen tube trailer,
d) opening a further fluidic communication between a remaining gaseous Hydrogen volume within the liquid Hydrogen tube trailer, the headspace of the cryogenic storage container and the Hydrogen liquefaction plant, which is capable of recondensing the gaseous Hydrogen, from the liquid Hydrogen tube trailer and the headspace of the cryogenic storage container, whereby a portion of the gaseous Hydrogen is moved by a third pressure difference from the liquid Hydrogen tube trailer and the headspace of the cryogenic storage container to the Hydrogen liquefaction plant,
e) once the liquid Hydrogen tube trailer is partially refilled with liquid Hydrogen, closing the fluidic communication with the headspace of the cryogenic storage container from step b) and the fluidic connection between the liquid Hydrogen output stream from a Hydrogen liquefaction plant and the tube trailer from step c), wherein the fluidic communication between the liquid Hydrogen tube trailer and the Hydrogen liquefaction plant from step d) remains open,
f) opening a fluidic communication between the liquid Hydrogen output stream from a Hydrogen liquefaction plant and the volume of liquid Hydrogen in the cryogenic storage container,
g) opening a fluidic communication between the volume of liquid Hydrogen in the cryogenic storage container and the volume of liquid Hydrogen within the liquid Hydrogen tube trailer, whereby an additional an additional volume of liquid Hydrogen is added to the liquid Hydrogen tube trailer due to a fourth pressure differential,
h) closing the fluidic communications of step g) when a pre-defined set of condition(s) indicates that refilling is complete.

2. The method of claim 1, wherein any one of the first to the fourth pressure differences are created, at least in part, by gas compression or liquid pumping.

3. The method of claim 2, wherein the first pressure difference is due to the liquid Hydrogen tube trailer having a gaseous Hydrogen pressure of 7-10 bar and the cryogenic storage tank having a headspace pressure of 1-2 bar.

4. The method of claim 3, wherein the headspace pressure in the cryogenic storage tank after step b), and before step c), is 0.1 to 1.0 bar higher than prior to step b).

5. The method of claim 1, wherein step e) begins when the liquid Hydrogen tube trailer is determined to be partially refilled based on a temperature of the tube trailer wall still in contact with gaseous Hydrogen being less than 200 K, preferably less than 150 K, such as 100-120 K.

6. The method of claim 1, wherein step e) begins when the liquid Hydrogen tube trailer is determined to be partially refilled based on a liquid Hydrogen volume occupying at least 30% of an interior total volume of the liquid Hydrogen tube trailer, more preferably at least 40%, and most preferably 45-55%.

7. The method of claim 1, wherein the pre-defined set of condition(s) indicates that refilling is complete in step h) comprises a liquid Hydrogen volume occupying at least 90% of an interior total volume of the liquid Hydrogen tube trailer, more preferably at least 93%, and most preferably 93-95%.
